(19) United States
(12) Patent Application Publication
(10) Pub. No.: US 2026/0099388 A1
(43) Pub. Date: Apr. 9, 2026

(54) PLUG-N-PLAY API INTEGRATION FRAMEWORK

(71) Applicant: Microsoft Technology Licensing, LLC, Redmond, WA (US)

(72) Inventors: Auon Haidar KAZMI, Monroe, WA (US); Sumit MANCHANDA, Kirkland, WA (US); Masroor Hussain SYED, Bothell, WA (US)

(21) Appl. No.: 18/906,113

(22) Filed: Oct. 3, 2024

(51) Int. Cl. G06F 9/54

(52) U.S. Cl. CPC G06F 9/54

(57) ABSTRACT

A framework uses a service table and an API table to autonomously invoke downstream APIs. The service and API tables collectively define configurable “properties” for establishing authentication with the downstream APIs, formatting and communicating API requests in a manner supported by the respective downstream APIs, and processing API responses received from the downstream APIs. Service level properties defined in the service table may be used to establish authentication with the downstream API as well as communicate API requests/responses in a manner supported by the downstream API. Request level properties defined in the API table may include any property used to format or otherwise generate an API request and/or process an API response in a manner supported by a corresponding downstream API.

### BACKGROUND

Application programming interfaces (APIs) allow computer programs to communicate with each other autonomously. In practice, upstream and downstream APIs are used by vendors and service providers to autonomously exchange information in the form of API requests and API responses. In particular, a vendor may use an upstream API to convert raw data (e.g., incoming requests) into API requests that are sent to multiple downstream APIs operated by different service providers. Each of the downstream APIs may process the corresponding API requests and return an API response to the upstream API. As an example, a mortgage broker (vendor) may operate an upstream API that interconnects with multiple downstream APIs operated by different lending institutions, e.g., Wells Fargo, FirstTech, etc. The mortgage broker may provide a borrower's raw information (e.g., income, credit score, etc.) in the form of an incoming request to the upstream API, which may convert the incoming request into multiple API requests to send to the corresponding downstream APIs operated by the lending institutions. The API requests are akin to mortgage applications and are processed by the downstream APIs to generate API responses (e.g., lending offers, rejections, etc.) to return to the upstream API. Because the downstream APIs are independent from one another, the corresponding API requests and response may typically have different requirements in terms of how the API requests are formatted and also in terms of how they are communicated. As an example, downstream APIs may utilize different authentication protocols as well as require different header formats, payload formats, validations, and transformations. In this sense, configuring an upstream API to integrate with different downstream APIs generally requires the upstream API's code to be custom configured by skilled technicians. Moreover, service providers may periodically update their downstream API configurations, which may further require the skilled technicians to modify the upstream API's code in order to maintain upstream-downstream integration. Small and medium-sized vendors often do not employ on-site skilled technicians in the way that enterprise companies might, and thus techniques for automating upstream API setup and maintenance is needed in order for API products/services to accessible to a wider market.

### SUMMARY

Some examples provide a method of receiving an incoming request from a client at an upstream application programming interface (API), converting the incoming request into an API request based on request properties defined in an API table, and sending the API request to a downstream API based on service properties defined in a service table. The request properties defined in the API table and the service properties defined in the service table are associated with the downstream API. The method further includes receiving an API response, responsive to the API request, based on the service properties defined in the service table, transforming the API response into an outgoing response based on the request properties defined in the API table, and sending the outgoing response to the client.

Other examples provide a system comprising processor(s) and computer-readable medium storing programming instructions that, when executed by the processor(s), cause the processor(s) to receive an incoming request from a client at an upstream application programming interface (API), convert the incoming request into an API request based on request properties defined in an API table, and send the API request to a downstream API based on service properties defined in a service table. The request properties defined in the API table and the service properties defined in the service table are associated with the downstream API. The programming instructions further cause the processor(s) to receive an API response, responsive to the API request, based on the service properties defined in the service table, transform the API response into an outgoing response based on the request properties defined in the API table, and send the outgoing response to the client.

Yet other examples provide computer program product comprising programming instructions that, when executed by processor(s), cause the processor(s) to receive an incoming request from a client at an upstream application programming interface (API), convert the incoming request into an API request based on request properties defined in an API table, and send the API request to a downstream API based on service properties defined in a service table. The request properties defined in the API table and the service properties defined in the service table are associated with the downstream API. The programming instructions further cause the processor(s) to receive an API response, responsive to the API request, based on the service properties defined in the service table, transform the API response into an outgoing response based on the request properties defined in the API table, and send the outgoing response to the client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram illustrating an integrated API system;

FIG. 2 is a diagram illustrating a service table;

FIG. 3 is a diagram illustrating an API table;

FIG. 4 is a flowchart of a method for using service and API tables for downstream API invocation;

FIG. 5 is a flowchart of another method for using service and API tables for downstream API invocation;

FIG. 6 is a functional block diagram of a computing apparatus.

Corresponding reference characters indicate corresponding parts throughout the drawings. Any of the figures may be combined into a single example or embodiment.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Aspects of this provide a framework for autonomously invoking downstream APIs using a service table and an API table. The service and API tables collectively define configurable “properties” for establishing authentication with the downstream APIs, formatting and communicating API requests in a manner supported by the respective downstream APIs, and processing API responses received from the downstream APIs. More specifically, the service table defines service level properties for establishing authenticated communications with the downstream APIs, while the API table defines request level properties for generating API requests that satisfy the requirements of the respective downstream APIs as well as for processing API responses received from the respective downstream APIs. In this way, the service properties defined in the service table may collectively specify invocation parameters for establishing authenticated communications with the downstream API, while the request properties defined in the API table may collectively specify an API request message format supported by an instance of the downstream API (aka “downstream API instance”) as well as processing parameters for API response messages received from the downstream API.

Service level properties (aka “service properties”) defined in the service table may be used to establish authentication with the downstream API as well as communicate API requests/responses in a manner supported by the downstream API. For example, service properties defined in the service table may include Service Name properties (e.g., ServiceName, Service Id, etc.), authentication properties (e.g., authentication type, Token Types, etc.) endpoint properties (e.g., RegionalURIs, RegionalRedirectURIs, etc.) for each downstream API, and correlation properties (e.g., correlation ID header, etc.) that allow users to establish correlations between API requests sent to different downstream APIs (e.g., API requests created from the same incoming client request). An authentication type property may specify how to generate certificate based tokens for a JSON web token (JWT) header in the API request, an API-key (Shared Access Signature concept), and/or a client secret to be used for token generation. The token type property may indicate whether a downstream API requires an App Bearer Token, on-behalf-of (OBO) token, authorization token, etc. Request level properties (aka “request properties”) defined in the API table may include any property used to format or otherwise generate an API request and/or process an API response in a manner supported by a corresponding downstream API (or downstream API instance). For instance, request level properties may include a service ID property identifying the corresponding service record (e.g., ServiceName), caching properties (e.g., CachingEnabled, CachingDuration, CacheKey) identifying caching requirements for API requests/responses, header properties (e.g., headersSpec, etc.) identifying formatting and information requirements of an API request/response header, payload properties (e.g., Payload Type, Payload Format, Payload Spec, etc.) identifying formatting and information requirements of an API request/response payload, as well as validation properties (e.g., keys) and transformation properties (e.g., request/response transformations and/or transformation-functions) for validating and/or processing/converting incoming requests into API requests and API responses into outgoing responses.

Each record in the service table specifies properties required to establish authentication with a downstream API. Each record in the API table will be cross-referenced with a corresponding record in the service table via the “serviceID” property. It should be appreciated that multiple records in the API table may be cross-referenced to a single record in the service table. The API table may specify properties for parsing out the API request's payload, header, cache key, and URL params from the incoming request. Validations may be performed on the parsed out data based on the payload property, etc. For example, a downstream API (e.g., Wellsfargo) requires a loan amount property in its payload to be a float value not greater than one million, and that requirement may be used to validate the API request payload to ensure the payload includes a loan amount within the required range (e.g., up to $1 M). The API table may also include a PayloadFormat property that specifies how to construct the payload, URL, cache key, and headers. The API table may further define a URL property that specifies how to construct the full URL for the downstream API (or downstream API instance). The API table may further define request/response transformations that specify how to transform the incoming request into an API request as well as how to transform the API response into an outgoing response.

The service table and API table may specify a JSON or typescript requirement (e.g., string, String/Enum, bool) for each defined service/request level property, as well as provide a description of each defined service/request level property. As an example, the service table may specify a string typescript requirement of the ServiceName property, as well as include a description that indicates that the ServiceName property specifies a service name of the underlying downstream API. This ensures that the upstream API uses a string typescript (as opposed to JSON, etc.) to identify the service name of the downstream API when establishing an authentication interconnection. Additionally, the service table and API table may specify sample values for each defined service/request level property of a downstream API or downstream API instance. The sample value may provide one or more examples of valid format(s) for the defined property. For example, the API table may define a list of valid website URLs (e.g., https://wellsfargo.com/) as the sample value for the RegionalURLs property of a given downstream API or downstream API instance. In some embodiments, the sample value provides an exhaustive list of all valid format(s) for the defined property. Further, the service table and API table may indicate whether a given property is required, conditionally required, or optional. For instance, the service table may indicate that a RegionalURLs property is required but that a Regional Redirect URLs property is optional, while the API table may indicate that a Cache duration property is conditionally required depending on whether caching is enabled for the corresponding downstream API instance. The service table and API table may be autonomously populated and/or updated based on API specifications (aka “Swagger docs”) released for the respective downstream APIs. In some examples, the service table may be dynamically configurable such that service properties (e.g., authentication type, token type, regional URLs type) may be updated to reflect a change in the corresponding property (e.g., a change in authentication services supported by the downstream API, a change in the token type(s) supported by the downstream API, etc.) without modifying the programming code of the upstream API. Likewise, the API table may be dynamically configurable such that request properties (e.g., caching duration, payload specification property, header specification property, etc.) may be updated to reflect a change in the corresponding property (e.g., a change in caching duration, a change in the payload properties required for the API requests exchanged with the downstream API, a change in the header fields required for the API requests exchanged with the downstream API, etc.) without modifying the programming code of the upstream API. This may allow for on-the-fly invocation of a modified downstream API or downstream API instance without interrupting the runtime operation of the upstream API or otherwise requiring manual reprogramming of the upstream API.

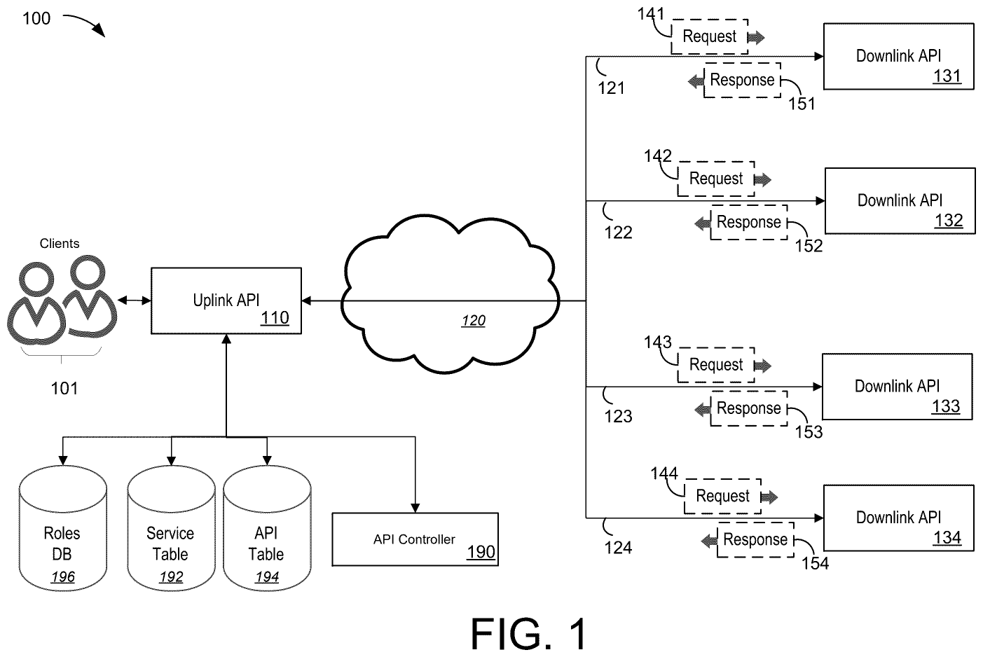

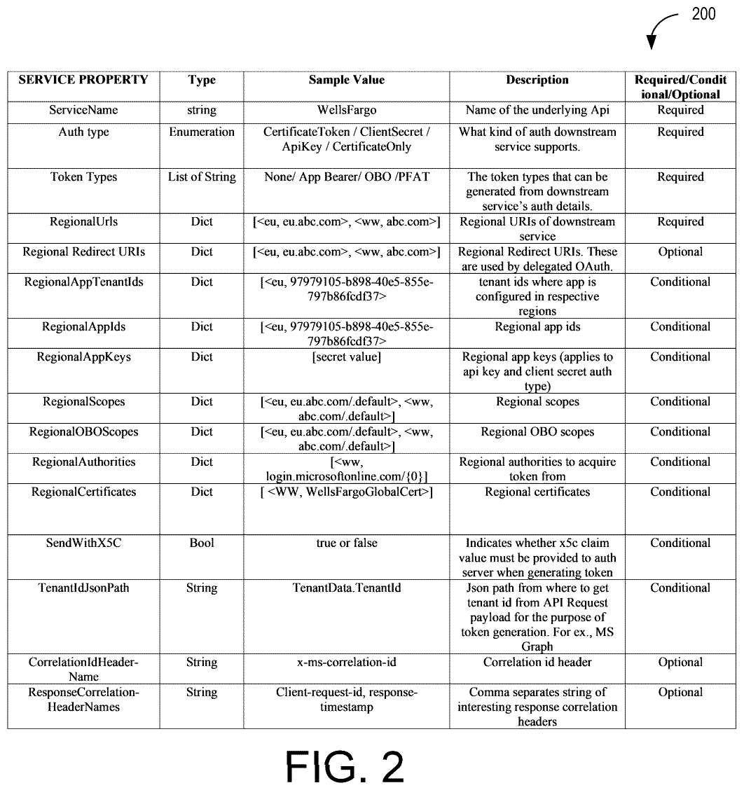

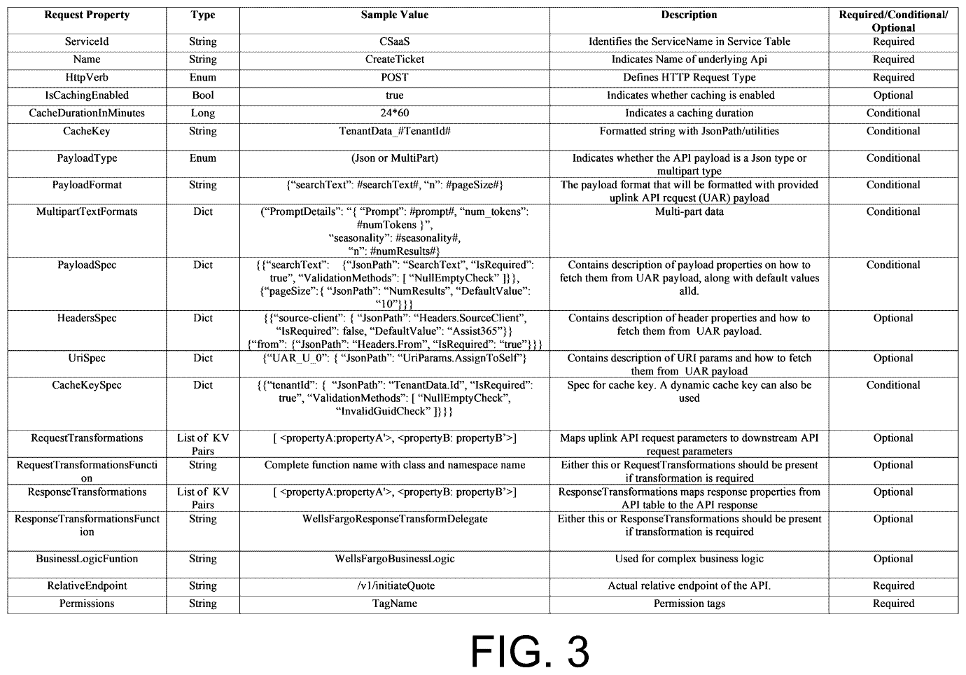

FIG. 1 is a diagram illustrating an integrated API system 100 that includes an upstream API 110 integrated with multiple downstream APIs 131, 132, 133, 134. As shown, the upstream API 110 is interconnected to the downstream APIs 131, 132, 133, 134 via authenticated channels 121, 122, 123, 124 extending over a network 120, e.g., the internet, etc. The upstream API 110 receives incoming requests from the client(s) 101, which include information (e.g., raw data) in a format (e.g., JSON) that is not supported by the downstream APIs 131, 132, 133, 134. The upstream API 110 may convert the incoming request into API requests 141, 142, 143, 144 based on service level and request level properties defined by the service table 192 and the API table 194. An example of the service table 192 is provided in FIG. 2 and an example of the API table 194 is provided in FIG. 3. Additionally, the uplink API 110 may reference the roles DB 196 to determine permissions, e.g., permissions corresponding to the permissions property in the API table 194.

The upstream API 110 then communicates the API requests 141, 142, 143, 144 to the downstream APIs 131, 132, 133, 134 over the authenticated channels 121, 122, 123, 124 based on service level properties defined by the service table 192. As an example, the API request 141 may be sent to a URL address specified by the RegionalURLs property defined for the downstream API 131.

The downstream APIs 131, 132, 133, 134 process the API requests 141, 142, 143, 144 and generate API responses 151, 152, 153, 154 to return to the upstream API 110 in response to the API requests 141, 142, 143, 144. Upon reception of the API responses 151, 152, 153, 154, the upstream API 110 transforms the API responses 151, 152, 153, 154 into outgoing responses, which are sent to the client(s) 101. The upstream API 110 may rely on service level properties defined by the service table 192 to receive the API responses 151, 152, 153, 154.

FIG. 2 is a diagram illustrating an example service table 200. As shown, the service table 200 defines a number of service properties, including (but not limited to) a ServiceName property, an Auth type property, a Token Types property, a RegionalUrls property, a Regional Redirect URLs property, a RegionalAppTenantIds property, a RegionalAppIds property, a RegionalAppKeys property, a RegionalScopes property, a RegionalOBOScopes property, a RegionalAuthorities property, a RegionalCertificates property, a SendWithX5C property, a TenantIdJsonPath property, a CorrelationIdHeader-Name property, and a ResponseCorrelation-HeaderNames property. These service properties defined by the service table 200 are associated with typescripts, sample values (e.g., examples of the service properties), description, and fields indicated whether the respective service properties are required/conditional/optional.

The ServiceName property indicates a name of the corresponding downstream API (e.g., WellsFargo), and is used to cross-reference an entry in the Service Table corresponding to a downstream API with entries in the API table corresponding to instances of the downstream API instances (aka “downstream API instances”). The ServiceName property is a sequence of characters having a string typescript (e.g., WellsFargoAPI) and is a required service property for each downstream API. The Authentication type (aka “auth type”) property indicates what kind of authorization a downstream API supports. For instance, the auth type property may indicate that the downstream API supports a CertificateToken, ClientSecret, APIKey, or CertificateOnly type authorization. The auth type property is associated with an enumeration typescript and is a required service property. The Token Types property indicates token types that can be generated from downstream service's auth details, is associated with a list of string typescript, and is a required service property. The RegionalUrls property indicates Regional URLs of downstream service, is associated with a List of KeyValue Pairs typescript, and is a required service property. The Regional Redirect URLs property indicates Regional Redirect URLs. These are used by delegated OAuth, is associated with a List of KeyValue Pairs typescript, and is an Optional service property. The RegionalAppTenantIds property indicates tenant IDs where app is configured in respective regions. The RegionalAppTenantIds property is associated with a List of KeyValue Pairs typescript and is a conditional service property that is enabled for downstream APIs that use tenant IDs. The RegionalAppIds property indicates Regional app IDs., is associated with a List of KeyValue Pairs typescript. The RegionalAppIds property is a conditional service property that is enabled for downstream APIs that use regional App IDs. The RegionalAppKeys property indicates regional app keys associated with an API keys and/or client secret auth types. The RegionalAppKeys property is associated with a List of KeyValue Pairs typescript and is a conditional service property that is enabled for downstream APIs that support API keys and/or client secret auth types. The RegionalScopes property indicates regional scopes associated with a downstream API (e.g., a geographical region assigned to the downstream API). RegionalScopes property is associated with a List of KeyValue Pairs typescript and is a conditional service property that is enabled for downstream APIs that are assigned to a specific region (as opposed to global downstream APIs). The RegionalOBOScopes property indicates regional on-behalf-of (OBO) scopes of downstream APIs to be used for fetching a user identity when a downstream API requires the user identity to be included in an OBO token. The OBO token may include an original user identity as well as pertinent uplink API information (e.g., client ID, scope, client secret, grant type, assertation, etc.). The RegionalOBOScopes property is associated with a List of KeyValue Pairs typescript and is a conditional service property that is enabled for downstream APIs assigned OBO regions. The RegionalAuthorities property indicates regional authorities from which auth token(s) are to be acquired from. The RegionalAuthorities property is associated with a List of KeyValue Pairs typescript and is a conditional service property that is enabled when a downstream API designates a regional authority for purposes of token authorization. The RegionalCertificates property indicates regional certificates from which auth certificates are to be acquired from. The RegionalCertificates property is associated with a list of keyvalue pairs typescript and is a conditional service property that is enabled when a downstream API designates a regional authority for purposes of certificate authorization. The SendWithX5C property indicates whether the upstream API should send an x5c claim value to the authorization server when generating a token (e.g., a JSON web token (JWT) to be included in the API request). The x5c claim value may be an array of strings that contains a certificate (e.g., an x.509 certificate chain) for verifying a digital signature associated with a JWT, e.g., for verifying the authenticity and/or integrity of the JWT for purposes of preventing JWT token abuse. The SendWithX5C property is associated with a Boolean typescript and is a conditional service property that is enabled when a downstream API requires verification of a JWT digital signature via an x5c claim value or when the CertificateToken Auth type is used. The TenantIdJsonPath property indicates Json path from where to get tenant ID from API Request payload for the purpose of token generation. TenantIdJsonPath property is a conditional service property that is enabled for downstream APIs that utilize tenant IDs. The CorrelationIdHeaderName property indicates a correlation ID header that allows API requests to be correlated with one another (e.g., API requests generated from the same incoming request, etc.). The CorrelationIdHeaderName property is associated with a string typescript and is an optional service property. The ResponseCorrelationHeaderNames property indicates a comma separated string of interesting response correlation headers, which may be used to fetch correlation headers from API response headers. The correlation headers may generally be used to log relationships for diagnostic purposes. The ResponseCorrelationHeaderNames property is associated with a string typescript and is an optional service property.

FIG. 3 is a diagram illustrating an example API table 300. As shown, the API table 300 defines a number of request properties, including (but not limited to) a ServiceId property, a Name property, a HttpVerb property, a IsCachingEnabled property, a CacheDurationInMinutes property, a CacheKey property, a PayloadFormat property, a MultipartTextFormats property, a PayloadSpec property, a HeadersSpec property, a URLSpec property, a CacheKeySpec property, a Request Transformations property, a RequestTransformationsFunction property, and a ResponseTransformations property, a Response TransformationsFunction property, a BusinessLogicFuntion RelativeEndpoint property, and a permissions property. The request properties defined by the service table 200 are associated with typescripts, sample values (e.g., examples of the request properties), descriptions, and fields indicated whether the respective service properties are required/conditional/optional.

The Service ID property is a foreign key that cross-references the service name property in the service table to indicate which service record a given API table record is associated with. The Service ID is associated with a string typescript and is a required request property for each downstream API. The Name property indicates the name of an underlying downstream API instance (e.g., FirstTech_GetQuote). The Name property is associated with a string typescrip, and is a required request property for each downstream API instance. The HttpVerb property indicates the API request type (e.g., POST, GET, PATCH, PUT, etc.) supported by a given downstream API instance. The HttpVerb property is associated with an Enum typescript and is a required request property for each downstream API instance. The IsCachingEnabled property indicates whether caching is enabled for a given downstream API instance. The IsCachingEnabled property is associated with a Boolean typescript and is an optional request property. The CacheDurationInMinutes property indicates a caching duration (in minutes) for downstream API instances that have caching enabled. The IsCachingEnabled property is associated with a long typescript and is a conditional request property that is enabled for downstream APIs that support caching. The CacheKey property indicates a formatted string for fetching values using JsonPath/utilities. The CacheKey property is associated with a string typescript and is a conditional request property that is enabled for downstream APIs that use Cache Keys. The PayloadFormat property indicates the payload format for API Request payloads of a given downstream API. The PayloadType property indicates a payload type (e.g., a JSON type payload, a multipart type payload) of the API request. A JSON type payload includes JSON values. A multipart type payload includes JSON values in addition to media (e.g., files, images, xml). The PayloadType property is associated with a string typescript and is a conditional request property that is enabled when the Http Verb property is set to GET. The PayloadFormat property is associated with a string typescript and is a conditional request property that is not required for downstream APIs in which the HttpVerb property is set to GET. The MultipartTextFormats property indicates multi-part data which may allow the API request to include media (e.g., files, images, xml) as part of the API payload. The MultipartTextFormats property is associated with a dictionary typescript, and is a conditional request property that is enabled when the payload type is multi-part. The PayloadSpec property indicates a description of payload properties as well as how to fetch the payload properties and also which payload properties may include default values. The PayloadSpec property is associated with a dictionary typescript and is a conditional request property that is enabled when the Payloadformat format property is enabled, and transformation of the API request payload is required. The HeadersSpec property contains a description of header properties as well as how to fetch them the header properties. The HeadersSpec property is associated with a dictionary typescript and is an optional request property for downstream APIs. The URLSpec property contains a description of URL parameters as well as how to fetch them (e.g., from a BAR Payload). The URLSpec property is associated with a dictionary typescript and is an optional request property for downstream APIs. The CacheKeySpec property provides the specification for a cache key. The CacheKeySpec property is associated with a dictionary typescript and is a conditional request property that is enabled when a cache key is used. It should be appreciated that a dynamic cache key may be used in lieu of or in addition to defining the CacheKeySpec property in the API table 300. The RequestTransformations property maps uplink API request parameters to downstream API request parameters. The RequestTransformations property is associated with a List of KeyValuePairs typescript and is an optional request property for each downstream API. The RequestTransformationsFunction property indicates whether API request transformation functions are required for a given downlink API. The RequestTransformationsFunction property is associated with a string typescript and is an optional request property. The Response Transformations property indicates a function for transforming API response data into defined property names. The ResponseTransformations property is associated with a list of KeyValuePairs (Dict) typescript and is an optional request property. The Response TransformationsFunction property indicates the name of a function for transforming API response data into JSON values when the ResponseTransformations property does not identify a function for transforming the API response data into defined property names. The Response TransformationsFunction property is associated with a string typescript and is an optional request property. The BusinessLogicFuntion property indicates whether a business logic function is provided, in which case the business logic function defines transformation functions, and the request/response transformation function properties are not specified. This BusinessLogicFuntion property is associated with a string typescript and is an optional request property. The RelativeEndpoint property indicates a relative endpoint of the downstream API (e.g.,/vl/users/{userId}). The RelativeEndpoint property is associated with a string typescript and is a required request property for each downstream API. The Permissions property indicates permission tags that will be assigned to roles of Uplink API security infrastructure, is associated with a string typescript, and is a required request property for each downstream API.

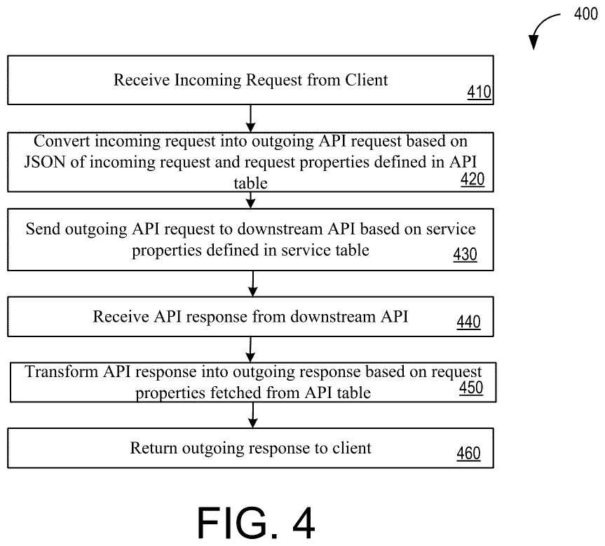

FIG. 4 is a flowchart of an embodiment method 400 for using service and API tables to invoke a downstream API. As shown, the method 400 begins with step 410, where the upstream API receives an incoming request from a client. At step 420, the upstream API converts the incoming request into an outgoing API request based on request properties defined in API table. In this step, the upstream API may perform a JSON search of the incoming request to identify values of header and payload properties, as well as identify request transformation properties for transforming the incoming request into the outgoing API request. In some examples, the upstream API may confirm that the client has permission to call on the corresponding downstream API based on the permission property defined in the API table, as well as format the API request according to payload and header properties defined in the API table (e.g., payload format, payload, header spec, etc.). For instance, the upstream API may use the payload spec property to construct a payload for the API request, as well as use the header spec property to parse out header data from incoming request and construct a headers dictionary for the API request. In some embodiments, the upstream API may use the URL spec property to parse out URI parameters and form the URL address for the downstream API, as well as use the cache key spec property to parse out data required to form the cache key. As an example, the cache tenant data property may be used to form a cache key (e.g., TenantData_<tenant_id>) and the cache key spec property may define how to extract the cache key (e.g., TenantData_<tenant_id>) from the incoming request. At step 430, the upstream API may send the outgoing API request to the downstream API (or downstream API instance) based on service properties defined in the service table. For example, the upstream API may configuration authentication of the API request based on authentication properties (e.g., Auth type, Token Type, etc.), as well as address the API request to a URL specified by the endpoint propert (ics) (e.g., RegionalURL(s), RegionalRedirectURL(s), etc.). At step 440, the upstream API receives an API response from the downstream API. At step 450, the upstream API transforms the API response into an outgoing response based on request properties (e.g., ResponseTransformations, ResponseTransformationsfunctions, etc.) defined in the API table. In one example, the ResponseTransformations property is set to true, and the upstream API transforms the API response based on a transformation function defined by the ResponseTransformationsfunctions. In another example, the Response Transformations property is set to false, and the upstream API returns the API response to the client as-is. At step 450, the upstream API returns the outgoing response to the client. In some examples, the service table may be dynamically configurable such that service properties (e.g., authentication type, token type, regional URLs type) may be updated to reflect a change in the corresponding property (e.g., a change in authentication services supported by the downstream API, a change in the token type(s) supported by the downstream API, etc.) without modifying the programming code of the upstream API. Likewise, the API table may be dynamically configurable such that request properties (e.g., caching duration, payload specification property, header specification property, etc.) may be updated to reflect a change in the corresponding property (e.g., a change in caching duration, a change in the payload properties required for the API requests exchanged with the downstream API, a change in the header fields required for the API requests exchanged with the downstream API, etc.) without modifying the programming code of the upstream API. This may allow for on-the-fly invocation of a modified downstream API or downstream API instance without interrupting the runtime operation of the upstream API or otherwise requiring manual reprogramming of the upstream API.

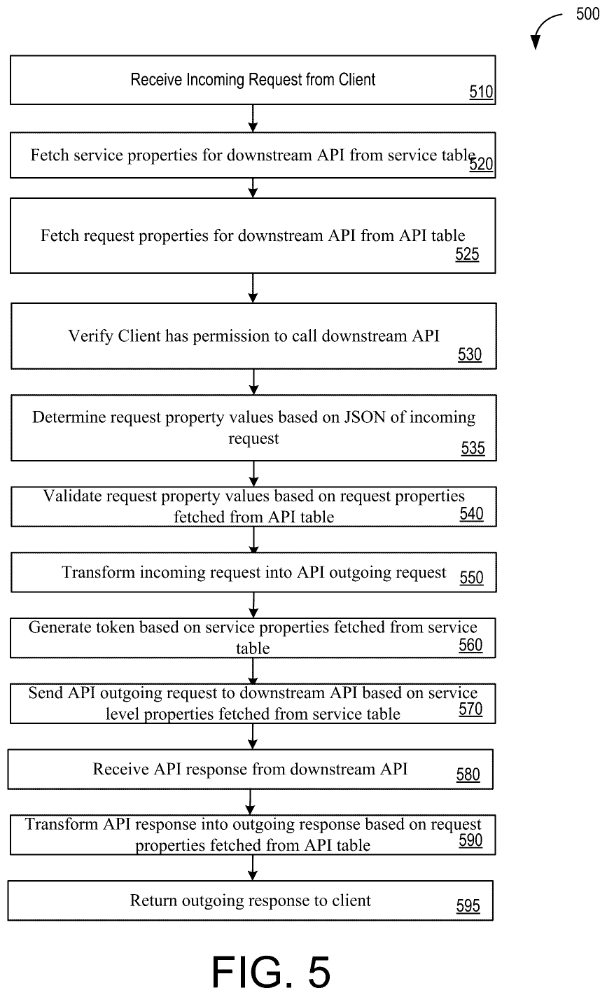

FIG. 5 is a flowchart of another embodiment method 500 for using service and API tables to invoke a downstream API. As shown, the method 500 begins with step 510, where the upstream API receives an incoming request from a client. At step 520, the upstream API fetches (e.g., GETs) service properties for the downstream API from the service table. At step 525, the upstream API fetches (e.g., GETs) request properties for the downstream API from the API table. At step 530, the upstream API verifies that the client has permission to call the downstream API based on the permission(s) propert(ies) defined by the API table. At step 535, the upstream API determines values for the fetched request properties based on a JSON search/scan of the incoming request. At step 540, the upstream API validates at least some of the request property value(s) based on request propert (ics) (e.g., PayloadSpec, etc.) fetched from the API table. The payload spec property may include a JSONPath field, an IsRequired field, a Default Value field, and a Validationmethods field. Examples of these fields can be seen in tables 1-6 below. The JSON path field for a payload property indicates a path within the API request payload in which the property is located (e.g., in table 2, the JSON path ApplicantsDetails.Name identifies the path for locating an ApplicantsName payload spec property). The “isRequired” field may indicate whether an API response payload is required to provide a value for a particular payload property. The “isRequired” field is set either to true to indicate that the API request payload must provide a non-default value for a given payload spec property or false to indicate that the API request payload is not required to provide a non-default value for a given payload spec property. If the “isRequired” field is set to true and the API request payload lacks a non-default value for the payload property, the uplink API will detect an error prior to transmitting the API request and return a 400 status code (Bad Request). If the “isRequired” field is set to false, then the API request payload may use a default value for the corresponding payload property. The DefaultValue field may be used when the IsRequired field is set to false, and may specify a default value to use for the corresponding payload spec property. The Validationmethods field may specify which validations are to be used for a given payload spec property. For example, the Validationmethods field may specify “PositiveNumberCheck” to ensure that the Data. Request.NumOfPages payload spec property is set to a specific or minimum number (e.g., five pages (−5), etc.), which may prompt the upstream API to throw a validation error when the Data. Request. NumOfPages payload spec property does not satisfy that criteria. At step 550, the upstream API transforms the incoming request into an API request based on request propert (ics) (e.g., RequestTransformations, RequestTransformationsFunctions, etc.) fetched from the API table. At step 560, the upstream API generate token(s) based on service properties (e.g., TokenTypes, etc.) fetched from the service table. For example, an MSAL library may be used to generate a token and a configured tenant ID may be used to form or otherwise determine an authority, in which case an APP ID, a certificate (or client secret), and a scope maybe determined based on a configuration such that the MSAL library may be invoked to obtain a token. At step 570, the upstream API sends the outgoing API request to the downstream API based on service level properties fetched from the service table. At step 580, the upstream API receives an API response from the downstream API. At step 590, the upstream API transforms the API response into an outgoing response based on request properties fetched from API table. At step 595, the upstream API returns the outgoing response to the client.

The framework provided herein may support an external call flow, where a caller (e.g., am UI Portal, third party, etc.) may call into the uplink API(s). The UI Portal API(s) may then reference an internal DB to GET a “configuration” for the underlying downstream API. Based on that configuration, an API request may be sent to the downstream API, which may provide an API response that is transformed into an outgoing response and returned to the original caller.

A downstream API may generally allow an upstream API to access a downstream service. As an example, WellsFargo provides a service that is accessed via Wellsfargo's downstream APIs. In this sense, a downstream service may effectively be defined by the service table and downstream API(s) may be effectively defined by the API table, where the service and API tables cross-reference the downstream service to the downstream API(s) using the service ID and service name properties.

The service table and API table may provide a configuration record that indicates all of the information that is needed to interact with an underlying downstream API, including data contract requirements, validation and authorization requirements, regional endpoints information, transformation information, API request/response header and payload requirements, and caching requirements. The service table and API table may be stored using a no-SQL DB (e.g., CosmosDB). In one example, a configuration service such as Skype's experimentation and configuration service (ECS) may be used to host the service and API tables. In one example, an open source such as Apache Zookeeper may be used to store the configuration.

The framework provided herein may support “Flighting.” For example, the API(s) or controllers may provide a role based access control (RBAC) infrastructure that defines “roles” that may be granted to user(s), service principal(s), tenant(s), SKU(s), etc. This role object model may include a property referred to as OmniOperationPermissions that lists all permission tags in the “permission” propert (ies) defined by the API Table. This may provide user(s) with the necessary permissions to call corresponding downstream APIs. Various methods may be used to effectuate flighting. As an example, in initial phase(s), a downstream API may be rolled out to a fixed number of users for integration testing. An AllowedUsers property allows role assignment to the users identified by email addresses. In some examples, client/user permissions will be determined based on permission tags within a Role property (e.g., OmniOpPerms), and each entity (e.g., client, user, etc.) that is assigned a role with a corresponding permissions tag. The permissions property may be fetched based on JWT token(s) sent to the API(s) or controllers. As another example, a tenant-based permissions model may be used by defining the AllowedTenantApps property inside role object model to allow for role assignment based on tenant to which caller belongs. This approach may be used during the production stage. As yet another example, a tenant+app-based role assignment may be used based on JWT token(s) provided by tenant(s) and/or generated for given apps (e.g., APP IDs, AZP claims in JWT token(s), etc.), which can effectively be used to assign the underlying role to user(s), etc. This may enable more granularity in terms of allowing calls from specific applications. For example, this approach may allow a given user to only make calls via the APIs or controllers from Microsoft Excel.

In terms of configuration storage, service and API tables may be stored as application settings.

In an embodiment, APIs and Internal flow may be established as a new method in a controller. This may provide better authorization control and also make it easier to maintain throttling. This may also include introducing a new controller for each new service onboarding, as well as a new method for each new API onboarding.

As mentioned above, a downstream API as defined by a service table record may correspond to multiple downstream API instances as defined by API table records. For example, a FirstTech downstream API may correspond to multiple FirstTech downstream API instances (e.g., FirstTech_GetQuote, FirstTech_GetLoanOptions, etc.), while a Wellsfargo downstream API may correspond to multiple Wellsfargo downstream API instances (e.g., Wellsfargo_GetQuote, Wellsfargo_ApplyLoan, etc.). Examples of these service/API table records are provided in Tables 1-6 below.

Table 1 is an example service table record for a FirstTech downstream API.

TABLE 1

```
“FirstTechService”: {
  “DownstreamService”: {
    “Id”: “FirstTech”,
    “Name”: “FirstTech”,
    “AuthType”: “CertificateOnly”,
    “TokenTypes”: {
      “0”: “None”
    },
    “RegionalURLs”: {
      “WW”: “https://firsttech.com/”
    },
    “RegionalCertificates”: {
      “WW”: {
        “Name”: “FirstTechGlobalCertificate”
      }
    },
    “CorrelationIdHeaderName”: “correlationId”
  }
}
```

Table 2 is an example API table record for a FirstTech downstream API instance.

```
TABLE 2
  “FirstTech_GetQuote”: {
    “DownstreamAPI”: {
      “Id”: “FirstTech_GetQuote”,
      “ServiceId”: “FirstTech”,
      “Name”: “FirstTech_GetQuote”,
      “HttpVerb”: “Post”,
      “PayloadType”: “Json”,
      “PayloadFormat”: “{\“Name\”: \“#ApplicantName#\”, \“Income\”:
\“#ApplicantIncome#\”, \“PropertyType\”: \“#PropertyType#\”,
\“PropertyAddress\”:
\“#PropertyAddress#\” }”,
      “PayloadSpec”: {
        “ApplicantName”: {
          “Type”: “String”,
          “JsonPath”: “applicantName”,
          “IsRequired”: true,
          “ValidationMethods”: {
            “0”: {
              “Type”: “NullEmptyCheck”
            }
          }
        },
        “ApplicantIncome”: {
          “Type”: “Long”,
          “JsonPath”: “applicantIncome”,
          “IsRequired”: true,
          “ValidationMethods”: {
            “0”: {
              “Type”: “NullEmptyCheck”
            },
            “1”: {
              “Type”: “PositiveNumberCheck”
            }
          }
        },
        “PropertyType”: {
          “Type”: “String”,
          “JsonPath”: “propertyType”,
          “IsRequired”: true,
          “ValidationMethods”: {
            “0”: {
              “Type”: “EnumCheck”,
              “Parameters”: {
                “enumValues”: “TownHome,Condo,SingleFamily”
              }
            }
          }
        },
        “PropertyAddress”: {
          “Type”: “String”,
          “JsonPath”: “propertyAddress”,
          “IsRequired”: true,
          “ValidationMethods”: {
            “0”: {
              “Type”: “NullEmptyCheck”
            }
          }
        }
      },
      “RelativeEndpoint”: “/v1/getLoanQuote”,
      “Permissions”: “FirstTech_GetLoanQuote”
    }
```

Table 3 is an example API table record for a FirstTech_GetQuote downstream API instance.

Table 3 is an example API table record for a FirstTech_GetLoanOptions downstream API instance.

TABLE 4

```
“FirstTech_GetLoanOptions”: {
  “DownstreamAPI”: {
    “Id”: “FirstTech_GetLoanOptions”,
    “ServiceId”: “FirstTech”,
    “Name”: “FirstTech_GetLoanOptions”,
    “HttpVerb”: “Get”,
    “UriSpec”: {
      “loanQuoteId”: {
        “Type”: “String”,
        “JsonPath”: “loanQuoteId”,
        “IsRequired”: true,
        “ValidationMethods”: {
          “0”: {
            “Type”: “NullEmptyCheck”
          }
        }
      }
    },
    “RelativeEndpoint”: “/v1/getLoanOptions/#loanQuoteId#”,
    “Permissions”: “FirstTech_GetLoanQuote”,
    “ResponseTransformations”: {
      “loan_length_type”: “TypeOfLoan”,
      “loan_interest”: “InterestRate”,
      “term_Length”: “LoanTerm”
    }
  }
}
```

It should be appreciated that API table records in tables 2-3 may be cross-referenced to the Service table record in table 1.

Table 4 is an example Service table record for a Wellsfargo downstream API.

TABLE 4

```
“WellsFargoService”: {
  “DownstreamService”: {
    “Id”: “WellsFargo”,
    “Name”: “WellsFargo”,
    “AuthType”: “CertificateToken”,
    “TokenTypes”: {
      “0”: “AppBearer”
    },
    “RegionalURLs”: {
      “WW”: “https://wellsfargo.com/”
    },
    “RegionalAppTenantIds”: {
      “WW”: “f3aef072-2b58-49b4-b965-7085e6b27f94”
    },
    “RegionalAppIds”: {
      “WW” : “1bac2795-eaa2-4e56-b7ca-ff3c966e2a71”
    },
    “RegionalScopes”: {
      “WW”: “https://wellsfargo.com/Loan.All”
    },
    “RegionalAuthorities”: {
      “WW”: “https://login.microsoftonline.com/{0}”
    },
    “RegionalCertificates”: {
      “WW”: {
        “Name”: “WellsFargoCertificate”
      }
    },
    “SendWithX5C”: true,
    “CorrelationIdHeaderName”: “RequestID”
  }
}
```

Table 5 is an example APR table record for a Wellsfargo_ApplyLoan downstream API instance.

```
TABLE 5
“WellsFargo_ApplyLoan”: {
  “DownstreamAPI”: {
    “Id”: “WellsFargo_ApplyLoan”,
    “ServiceId”: “WellsFargo”,
    “Name”: “WellsFargo_ApplyLoan”,
    “HttpVerb”: “Post”,
    “PayloadType”: “Json”,
    “PayloadFormat”: “{\“loanApplicationId\”: \“#LoanApplicationId#\”,
    \“dateTime\”:
\“#DateTime#\” }”,
    “PayloadSpec”: {
      “LoanApplicationId”: {
        “Type”: “String”,
        “JsonPath”: “loanApplicationId”,
        “IsRequired”: true,
        “ValidationMethods”: {
          “0”: {
            “Type”: “NullEmptyCheck”
          }
        }
      },
      “DateTime”: {
        “Type”: “String”,
        “JsonPath”: “timeStamp”,
        “IsRequired”: true,
        “ValidationMethods”: {
          “0”: {
            “Type”: “DateFormatCheck”
          }
        }
      }
    },
    “RelativeEndpoint”: “api/v1/loan/apply”,
    “Permissions”: “WellsFargo_ApplyLoan”
  }
}
```

Table 6 is an example APR table record for a Wellsfargo_GetQuote downstream API instance.

```
TABLE 6
“WellsFargo_GetQuote”: {
  “DownstreamAPI”: {
    “Id”: “WellsFargo_GetQuote”,
    “ServiceId”: “WellsFargo”,
    “Name”: “WellsFargo_GetQuote”,
    “HttpVerb”: “Post”,
    “PayloadType”: “Json”,
    “PayloadFormat”: “{\“UserName\”: \“#Name#\”, \“AnnualIncome\”:
\“#AnnualIncome#\”, \“Address\”: \“#Address#\” }”,
    “PayloadSpec”: {
      “Name”: {
        “Type”: “String”,
        “JsonPath”: “ApplicantDetails.Name”,
        “IsRequired”: true,
        “ValidationMethods”: {
          “0”: {
            “Type”: “NullEmptyCheck”
          }
        }
      },
      “AnnualIncome”: {
        “Type”: “Double”,
        “JsonPath”: “ApplicantDetails.AnnualIncome”,
        “IsRequired”: true,
        “ValidationMethods”: {
          “0”: {
            “Type”: “NullEmptyCheck”
          },
          “1”: {
            “Type”: “PositiveNumberCheck”
          }
        }
      },
      “Address”: {
        “Type”: “String”,
        “JsonPath”: “ApplicantDetails.Address”,
        “IsRequired”: true,
        “ValidationMethods”: {
          “0”: {
            “Type”: “NullEmptyCheck”
          }
        }
      }
    },
    “UriSpec”: {
      “ClientAppName”: {
        “Type”: “String”,
        “JsonPath”: “clientApp”,
        “IsRequired”: false,
        “DefaultValue”: “Web”
      }
    },
    “RelativeEndpoint”:
    “/v1/getQuickQuote?clientApp=#ClientAppName#”,
    “Permissions”: “WellsFargo_GetQuickQuote”
  }
}
```

It should be appreciated that API table records in tables 5-6 may be cross-referenced to the Service table record in table 4.

### Exemplary Operating Environment

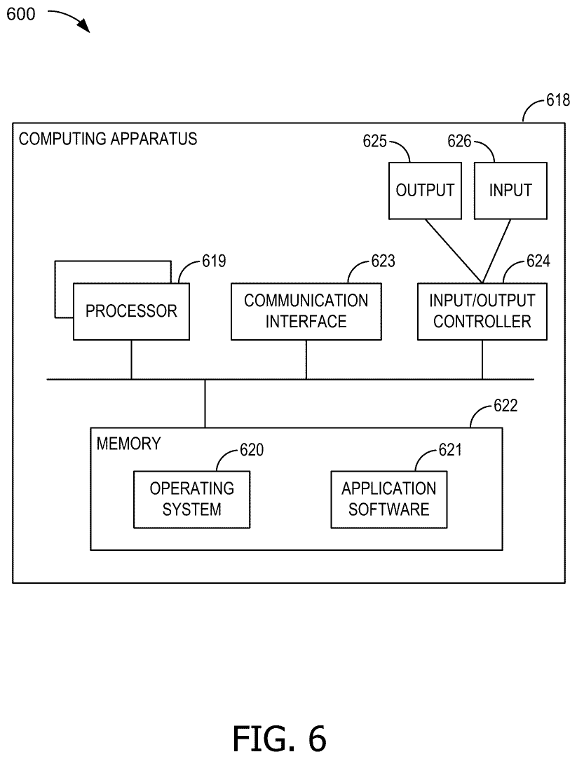

The present disclosure is operable with a computing apparatus according to an embodiment as a functional block diagram 600 in FIG. 6. In an example, components of a computing apparatus 618 are implemented as a part of an electronic device according to one or more embodiments described in this specification.

The computing apparatus 618 comprises one or more processors 619 which can be microprocessors, controllers, or any other suitable type of processors for processing computer executable instructions to control the operation of the electronic device. Alternatively, or in addition, the processor 619 is any technology capable of executing logic or instructions, such as a hardcoded machine. In some examples, platform software comprising an operating system 620 or any other suitable platform software is provided on the apparatus 618 to enable application software 621 to be executed on the device.

In some examples, computer executable instructions are provided using any computer-readable medium or media accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 in other examples outputs data to devices other than the output device, e.g., a locally connected printing device. In some examples, a user provides input to the input device(s) 626 and/or receives output from the output devices 625.

The functionality described herein can be performed, at least in part, by one or more hardware logic components. The computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for receiving a first search request, the first search request including one or more search terms; identifying one or more product categories as output from a machine learning classification model in response to inputting of the one or more search terms; identifying a first plurality of products that are assigned to the one or more product categories, each product of the first plurality of products including a plurality of product titles and a plurality of product short descriptions in a natural language; applying the plurality of product titles and the plurality of product short descriptions as input to a second machine learning model that is configured to generate a plurality of recommended searches, each recommended search of the plurality of recommended searches including at least one search term; scoring each recommended search of the plurality of recommended searches; selecting one or more recommended searches of the plurality of recommended searches based on the scoring; and causing the one or more recommended searches to be displayed as user-interactable components on a graphical user interface, each user-interactable component being configured to execute a second search request upon user interaction with the user-interactable component.

At least a portion of the functionality of the various elements in FIG. 1 to FIG. 6 can be performed by other elements.

In some examples, the operations described herein can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving, by an upstream application programming interface (API), an incoming request from a client;
converting, by the upstream API, the incoming request into an API request based on request properties defined in an API table, wherein the request properties defined in the API table are associated with a downstream API;
sending, by the upstream API, the API request to the downstream API based on service properties defined in a service table, wherein the service properties defined in the service table are associated with the downstream API;
receiving, from the downstream API, an API response based on the service properties defined in the service table, the API response being responsive to the API request;
transforming the API response into an outgoing response based on the request properties defined in the API table; and
sending the outgoing response to the client.

2. The method of claim 1, wherein the service properties defined in the service table collectively specify invocation parameters for establishing authenticated communications with the downstream API.

3. The method of claim 1, wherein the request properties defined in the API table collectively specify an API request message format supported by an instance of the downstream API.

4. The method of claim 1, wherein the service properties defined by the service table include an authentication type property that specifies authentication service(s) supported by the downstream API.

5. The method of claim 4, further comprising:
updating the authentication type property defined by the API table to reflect a change in the authentication service(s) supported by the downstream API.

6. The method of claim 5, wherein the authentication type property is updated without modifying a programming code of the upstream API.

7. The method of claim 4, wherein the service properties defined by the service table further include a token type property that specifies token type(s) supported by the downstream API.

8. The method of claim 7, further comprising:
updating the token type property defined by the service table to reflect a change in the token type(s) supported by the downstream API, wherein the token type property is updated without modifying a programming code of the upstream API.

9. The method of claim 1, wherein the service properties defined by the service table include a regional URLs property that specifies regional URL addresses registered to the downstream API.

10. The method of claim 1, wherein the request properties defined by the API table includes a caching enabled property that indicates whether API messages exchanged with the downstream API are required to be cached by the upstream API.

11. The method of claim 10, wherein the request properties defined by the API table further include a caching duration property that indicates a minimum caching duration for the API messages exchanged with the downstream API.

12. The method of claim 11, further comprising:
updating the caching duration property defined by the API table to reflect a change in the minimum caching duration for API messages exchanged with the downstream API, wherein the caching duration property is updated without modifying a programming code of the upstream API.

13. The method of claim 1, wherein the request properties defined by the API table include a payload specification property that defines payload properties required for API requests exchanged with the downstream API.

14. The method of claim 13, further comprising:
updating the payload specification property defined by the API table to reflect a change in the payload properties required for the API requests exchanged with the downstream API, wherein the payload specification property is updated without modifying a programming code of the upstream API.

15. The method of claim 1, wherein the request properties defined by the API table include a header specification property that defines header fields required for API requests exchanged with the downstream API.

16. The method of claim 15, further comprising:
updating the header specification property defined by the API table to reflect a change in the header fields required for the API requests exchanged with the downstream API, wherein the header specification property is updated without modifying a programming code of the upstream API.

17. The method of claim 1, wherein the request properties defined by the API table include a response transformations property that defines a function for transforming API responses received from the downstream API into outgoing responses.

18. The method of claim 1, wherein the request properties defined by the API table include a permissions property that defines which clients are permitted to send API requests to the downstream API.

19. A system comprising:
processor(s); and
computer-readable medium storing programming instructions that, when executed by the processor(s), cause the processor(s) to:
receive, at an upstream application programming interface (API), an incoming request from a client;
convert the incoming request into an API request based on request properties defined in an API table, wherein the request properties defined in the API table are associated with a downstream API;
send the API request to the downstream API based on service properties defined in a service table, wherein the service properties defined in the service table are associated with the downstream API;
receive an API response based on the service properties defined in the service table, the API response being responsive to the API request;
transform the API response into an outgoing response based on the request properties defined in the API table; and
send the outgoing response to the client.

20. A computer program product comprising programming instructions that, when executed by processor(s), cause the processor(s) to:
receive, at an upstream application programming interface (API), an incoming request from a client;
convert the incoming request into an API request based on request properties defined in an API table, wherein the request properties defined in the API table are associated with a downstream API;
send the API request to the downstream API based on service properties defined in a service table, wherein the service properties defined in the service table are associated with the downstream API;
receive an API response based on the service properties defined in the service table, the API response being responsive to the API request;
transform the API response into an outgoing response based on the request properties defined in the API table; and
send the outgoing response to the client.
